(19) United States
(12) Patent Application Publication
(10) Pub. No.: US 2008/0047994 A1
(43) Pub. Date: Feb. 28, 2008

(54) HOLDING SYSTEM FOR TRANSPORTING TWO WHEELED VEHICLES

(76) Inventors: Henry E. Beamer, Middleport, NY (US); Susan W. Beamer, Middleport, NY (US)

Correspondence Address: JAECKLE FLEISCHMANN & MUGEL, LLP, 190 Linden Oaks, ROCHESTER, NY, 14625-2812, US

(21) Appl. No.: 11/845,329

(22) Filed: Aug. 27, 2007

Related U.S. Application Data
(60) Provisional application No. 60/823,690, filed on Aug. 28, 2006.

(51) Int. Cl. B60R 9/10

(52) U.S. Cl. 224/403

(57) ABSTRACT

A bike-holding system for transporting one or more two-wheeled vehicles in a bed of a transportive vehicle includes a first holder comprising a plate interrupted by one or more elongated slots, each slot being adapted to receive a first wheel of a two-wheeled vehicle, which first wheel may be either a front or rear wheel. The plate is inclined at an angle to the plane of the bed. The system may include a second holder comprising a second plate interrupted by one or more elongated slots or pairs of rails, each of the elongated slots or rail pairs being adapted to receive a second wheel of the two-wheeled vehicle. A two-wheeled vehicle thus installed in a holder or holders of the invention is restrained from lateral (tipping) motion or vertical motion with respect to the bed by one or more hold-downs attached to the two-wheeled vehicle and the transporting vehicle.

### RELATIONSHIP TO OTHER APPLICATIONS AND PATENTS

The present application draws priority from a pending U.S. Provisional Patent Application Ser. No. 60/823,690, filed Aug. 28, 2006.

### TECHNICAL FIELD

The present invention relates to devices for retaining a wheeled vehicle on a motorized vehicle for transport thereby; more particularly, to a bicycle (“bike”) rack for retaining a two-wheeled vehicle for transport in the bed of a truck or a van; and most particularly to a system for holding a two-wheeled vehicle, such as a bicycle, motorcycle, or motor scooter, that positions and holds the two-wheeled vehicle intact and upright during transportation thereof by a transportive vehicle.

### BACKGROUND OF THE INVENTION

As used herein, the terms “bicycle” and “bike” are interchangeable, and the term “rack” should be understood to mean generically a device for holding a bicycle or bike. Further, these terms and the present invention apply generically to any two-wheeled form of transportation, either pedal-powered or motorized, that may be transported while standing on its own wheels, although the discussion herein is directed for purposes of simplicity to a bicycle.

Numerous prior art bicycle rack arrangements exist in the market place for transporting bicycles in pickup truck beds. Generally, these arrangements experience problems in use that limit their effectiveness and utility. Many are heavy, expensive, and/or require significant storage space when not in use. Many require permanent alteration to the truck, such as drilling. Further, installation and removal of a prior art rack from the truck can be difficult or time-consuming, and frequently a bike is not restrained securely during transport, leaving both the bike and truck susceptible to damage.

Prior art arrangements fall into two main categories: bed-mount and rear-mount.

Bed-mount arrangements typically require disconnecting a bike's front brakes and removing the bike's front wheel, which must be stowed separately. Typically, with the bike facing either forwards or aftwards of the truck, the front fork is attached to a fitting secured to the bed floor of the truck, to the bed side rails, or to the truck roof. Typically, the rear end of the bike is unrestrained, which can constitute a safety problem in the event of a collision and which leaves the bike susceptible to damage.

Rear-mount arrangements typically involve attaching a carrier to the rear bumper or trailer hitch of a truck or van. Bumper mount arrangements typically require straps and/or other features that can damage the truck paint and allow the mounted bikes to move relative to each other which can result in the bike paint being scratched. Security is dependent on proper rack mounting and vehicle architecture, as well as installation technique. Hitch mount arrangements require installation of a trailer hitch. Bumper-mount and hitch-mount arrangements both leave the bikes very vulnerable to damage from rear collisions, and most such arrangements do not restrain the front wheel from swinging in the fork tube which creates the potential for bike-to-bike damage when multiple bikes are carried. Moreover, it may be difficult to prevent damage to the bikes due to contact between pedals, chains, derailleurs, handlebars, and wheels during the mounting and removal of multiple bikes. Also the rear mounting position exposes bikes to dirt, debris, and water from the road surface during transport. Most of these prior art arrangements lack sufficient security to restrain the bikes vertically and horizontally in the event of a collision or extreme vehicle maneuvering.

What is needed in the art is an improved holding system for secure positioning and restraint of one or more two-wheeled vehicles in a flatbed vehicle during transportation thereby that is relatively inexpensive to fabricate; easy to handle; simple to install in the transporting vehicle without tools or fasteners; and requires no defacing or alteration of the transporting vehicle.

It is a primary objective of the invention to provide means for safely and securely transporting one or more two-wheeled vehicles in the bed of a truck or van.

### SUMMARY OF THE INVENTION

Briefly described, a bike-holding system in accordance with the invention for transporting one or more two-wheeled vehicles in a flatbed of a transportive vehicle includes at least a first holder comprising a plate interrupted by one or more elongated slots, each slot being adapted to receive a first wheel of a two-wheeled vehicle, which first wheel may be either a front or rear wheel. The plate is inclined at an angle to the plane of the flatbed. The system may include a second holder comprising a second plate interrupted by one or more elongated slots or pairs of rails, each of the elongated slots or rail pairs being adapted to receive a second wheel of the two-wheeled vehicle. A two-wheeled vehicle thus installed in a holder or holders of the invention is restrained from lateral (tipping or twisting) motion or vertical motion with respect to the flatbed by one or more hold-downs attached to the two-wheeled vehicle and the transportive vehicle.

### BRIEF DESCRIPTION OF THE DRAWINGS

The present invention will now be described, by way of example, with reference to the accompanying drawings, in which:

FIG. 1 is a perspective view of first and second holders in accordance with the invention disposed in the bed of a pickup with two bicycles mounted in the holders and secured to the truck by tie-downs;

FIG. 2A is a plan view of a first holder in accordance with the invention;

FIG. 2B is a side view of the first holder shown in FIG. 2A;

FIG. 2C is an end view of the first holder shown in FIG. 2A;

FIG. 3 is a perspective view showing a wheel disposed in an arcuate pocket formed in a portion of a first holder in accordance with the invention;

FIG. 4A is a plan view of a first embodiment of a second holder in accordance with the invention, showing slots formed in a plate between a pair of flanges extending from the plate;

FIG. 4B is a side view of the second holder shown in FIG. 4A;

FIG. 4C is an end view of the second holder shown in FIG. 4A;

FIG. 5 is a perspective view of a wheel mounted in a slot in a second embodiment of a second holder in accordance with the invention, showing chamfered upward flanges on either side of the wheel defining a slot while lacking a slot formed in the base plate;

FIG. 6 is a view like that shown in FIG. 5, showing flanges formed without chamfers;

FIG. 7 is a perspective view of the embodiment shown in FIG. 6;

FIG. 8 is a perspective view of three wheels of three separate vehicles mounted in the slots of a second holder;

FIG. 9 is an elevational view, partly in cross-section, showing a bicycle mounted in first and second holders in accordance with the invention, the bicycle facing rearwards of a truck bed;

FIG. 10 is an elevational view, partly in cross-section, showing a bicycle mounted in first and second holders in accordance with the invention, the bicycle facing forwards of a truck bed;

FIG. 11 is an elevational view, partly in cross-section, showing a flange extending from a plate in a first holder for engaging a truck bed supporting the first holder to position the plate non-horizontally; and

FIG. 12 is an elevational view of a second embodiment of a first holder, partly in cross-section, showing flanges extending from the base plate toward the axis of a wheel disposed in the first holder.

### DETAILED DESCRIPTION OF THE INVENTION

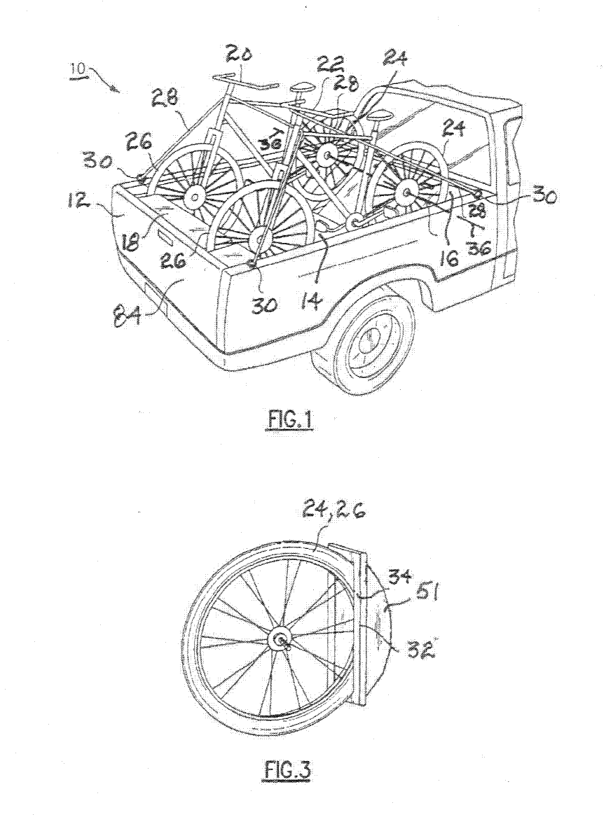

Referring to FIG. 1, a system 10 in accordance with the invention for transporting a wheeled vehicle in a generally upright position in the bed of a transportive vehicle is shown on a portion of a transportive vehicle in the form of a pickup truck 12 including a bed 14 thereof. System 10 comprises a first holder 16 and may further comprise a second holder 18. Two bicycles 20,22 are mounted in bed 14 having respective first wheels 24 disposed in first holder 16 and having respective second wheels 26 disposed in second holder 18. First and second tie-down straps 28 pass over, and preferably are attached to, or wrapped around, the respective frames of bicycles 20,22 and are attached to truck 12, for example, at integral tie-down rings 30 to constrain bicycles 20,22 both vertically and laterally of truck 12 during transportation of the bicycles.

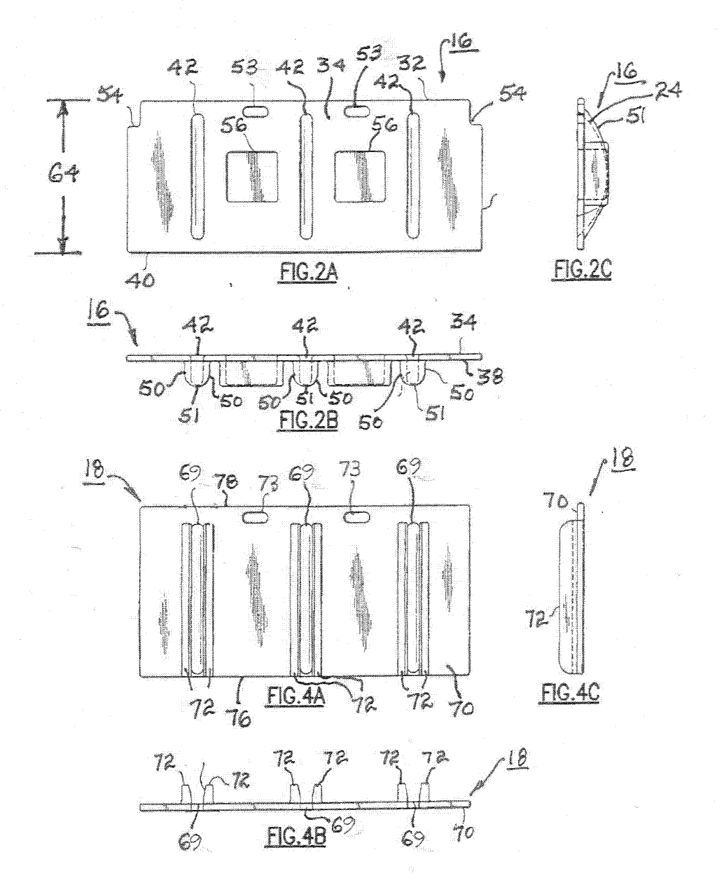

Referring to FIGS. 2A through 2C, perspective views are shown of the top, side, and end, respectively, of first holder 16. A plate 32 has a first surface 34 facing toward the axis 36 (FIG. 1) of first wheel 24 when in use and a second surface 38 opposite first surface 34. Plate 32 has a first generally horizontal edge 40 defining a horizontal direction and has at least one elongate opening 42 defining a slot extending away from generally horizontal edge 40. Slot 42 is formed in plate 32 for receiving first wheel 24 and for engaging first wheel 24 at first and second points 44,46 along a chord 48 of first wheel 24 (see FIGS. 9 and 12). A pair of flanges 50 extend orthogonally from one of first and second surfaces 34,38 at opposite sides respectively of slot 42 for engaging first wheel 24 at a third point 52 (FIGS. 9 and 12) such that a first plane contained in the rim of first wheel 24 is generally orthogonal to a second plane contained in plate 32 (wheel is upright). Preferably, the pair of flanges 50 define the sides of an arcuate pocket 51, as shown in FIG. 3. First holder 16 is capable of holding a free-standing bike upright by virtue of contact of first wheel 24 at the three points 44,46, and 52. Cut outs 53 in plate 32 may be provided along the upper edge for hand holds. Square cutouts 54 may be provided at the upper corners for access to truck bed tie down rings 30. Hand holds 53 may also serve as mounting points for hanging first holder 16 on a wall for storage. Storage compartments 56 and other features may be incorporated in the space between wheel slots 42 in plate 32.

A positioner is required to position first holder 16 at a first angle 58 to the front wall 57 of truck bed 14 and a complementary angle 60 to floor 62 of truck bed 14 (see FIG. 11). For example, the length 64 (FIG. 2A) of first holder 16 may be such that first holder 16 fits securely between front wall 57 and wheel wells 66 (FIG. 11). For another example, to adapt for fore-aft dimension variation of other truck designs, a projection such as a plate or legs may be extended from second surface 38. In yet another and currently preferred example, a projection may be provided in the form of an angled flange 68 (FIG. 11) for engaging bed floor 62. Any of these or other positioner examples that may occur to one of ordinary skill in the art can serve to position plate 32 non-horizontally at angle 60 without requiring support from bed wall 57.

For security against theft, first holder 16 may be secured conventionally to tie-down rings 30 with a conventional bike lock or chain (not shown) strung through hand hold cut outs 53 or other feature provided for the purpose.

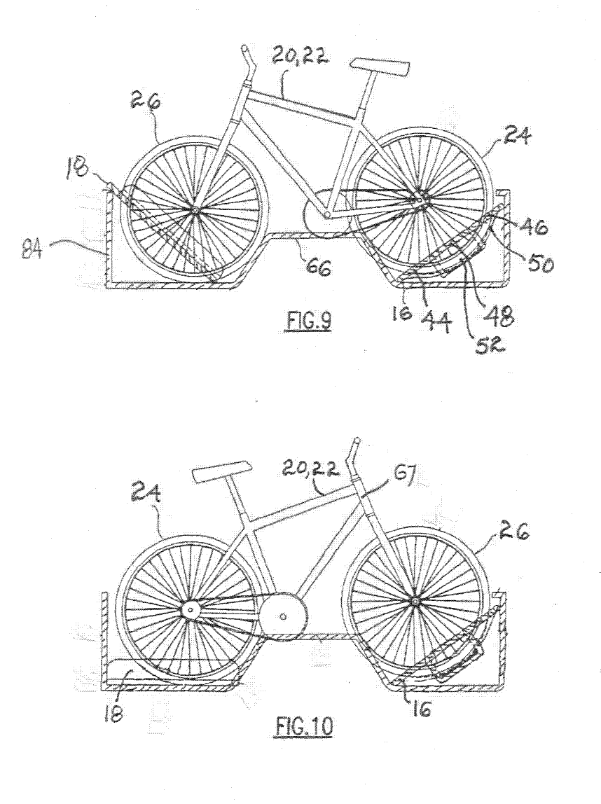

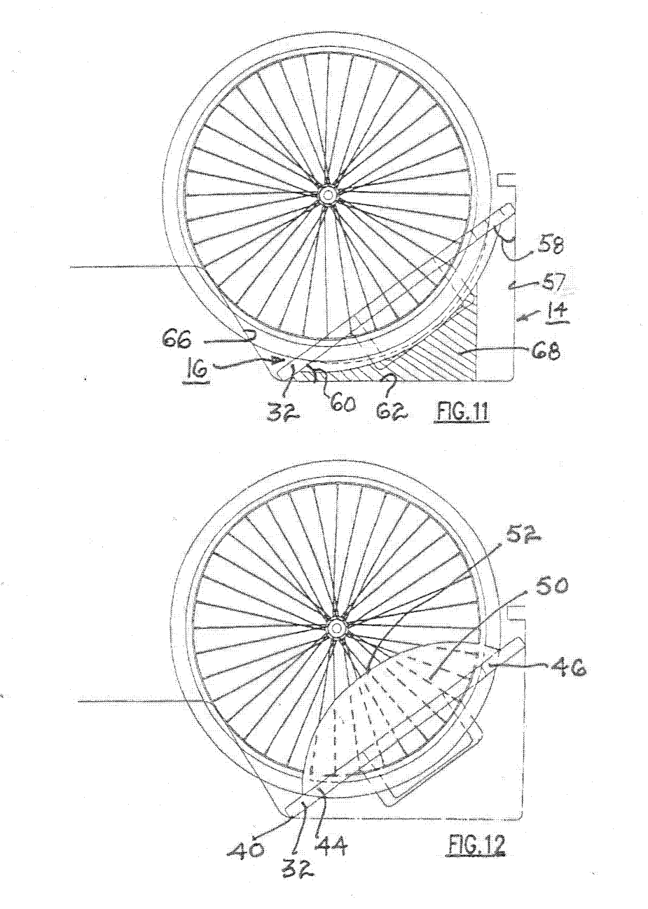

System 10 is capable of holding a two-wheeled vehicle in an upright position using first holder 16 alone without lateral swinging of the bicycle frame and front wheel 26 when the first wheel held by first holder 16 is a rear wheel 24 as shown in FIGS. 1 and 9, because wheel 24 is not pivotably mounted to the bicycle frame. However, when the first wheel held by first holder 16 is a front wheel 26, as shown in FIG. 10, the bicycle frame and rear wheel 24 may pivot freely on bicycle fork tube 66. Thus, a second holder 18 may be added to system 10 to assist in preventing swinging of the bicycle frame and rear wheel 24 about tube 67.

Second holder 18 is arranged in a manner similar to first holder 16, as shown in FIGS. 4A through 4C. Elongated slots 69 are provided in a base plate 70, preferably but not necessarily extending therethrough, to receive and retain one or more second wheels 26. Slots 69 are positioned to align laterally with slots 42 in first holder 16 as shown in FIG. 1. Upward-facing pairs of flanges 72 extending from plate 70 on opposite sides of slots 69 provide three point contact with second wheel 26. Further, flanges 72 conveniently guide wheels 24,26 during installation of a bike into system 10 and provide lateral support to two-wheeled vehicles during installation and transport thereof.

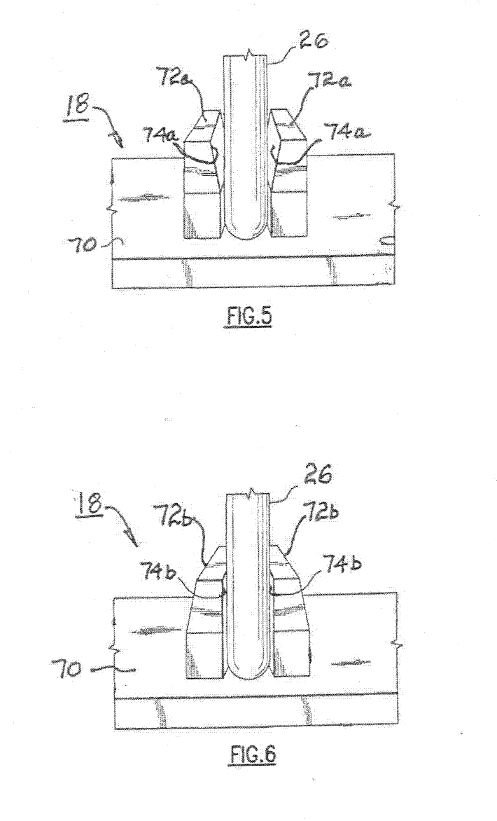

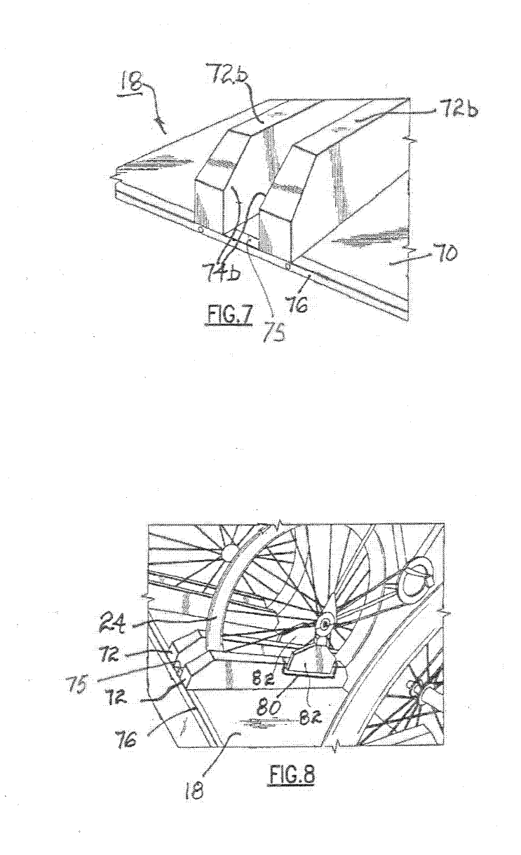

Second holder 18 may be mounted in the bed in an inclined (FIG. 9) or flat (FIG. 10) position. For inclined mounting, the inward-facing flange surfaces 74a of flanges 72a preferably are chamfered as shown in FIG. 5 to provide lead-in for the tires. For flat mounting (FIG. 10), flange surfaces 74b need not be chamfered and a higher flange 72b can be used to provide increased lateral support for the wheel (FIGS. 6 and 7). It is desirable to close slots 68 locally along the lower edge 76 and also the upper edge 78 to provide additional structural support to second holder 18 as shown in FIG. 4A. The closeouts 75 are adjacent to the bed surface and do not significantly impede the bike wheel as the flanges remain open. For holders intended to be mounted in the flat position, the slot closeouts may be extended the length of the slots 68 to form slot bottoms, or the slots may be omitted entirely. While not required for retention of the bike, closeouts improve holder stiffness and strength for handling. For inclined mounting of rear wheels 24, it is also desirable to provide cutouts 80 in flanges 72 to provide clearance for the bike derailleur 82 in the case where the bike is mounted facing forward of truck 12. Full support of the wheel is maintained as the wheel contacts the flanges only near the ends of the slots. Interference between the derailleur and an unmodified flange 64 is shown in FIG. 8.

Hand hold cutouts 73 are provided similar to those of front holder 18. The overall width of rear holder 20 may be reduced relative to front holder 18 to provide clearance for the rear bed post of truck 12 adjacent to tail gate 84 (FIG. 1). Anti-theft security and variations in bed dimensions can be accommodated as for first holder 16. For ease of manufacture, another first holder 16 may be substituted for second holder 18 and mounted (after rotation 1800) in a horizontal or inclined position in place of second holder 18.

Loading and operation of system 10 in accordance with the invention is very straightforward. First and second holders 16,18 are positioned in the truck bed as shown in FIG. 1. The bikes then are loaded one at a time so that the forward facing (first) wheel 24 engages the desired slot 42 in first holder 16 and the rearward facing (second) wheel 26 engages a corresponding slot 69 in second holder 18. First holder 16 as shown in FIGS. 2A and 2B is capable of holding three bikes. While the system shown in the drawings is designed to accommodate three bikes, holders 16,18 may be shortened laterally to hold fewer than three bikes or widened to hold four or more bikes on full size pick up truck beds. For the case of transporting a single two-wheeled vehicle, any set of slots 42 and 69 may be used, but the center slots are preferred. In the case that two bikes are to be placed in system 10, any two sets of slots 42 and 69 may be used, but the outside slots are preferable. In the case of three bikes, all slots 42 and 69 are used. Further, it is desirable to mount the vehicles alternately facing forward and rearward to avoid interference between handlebars of adjacent vehicles as shown in FIGS. 9 and 10.

Second holder 18 may be used in an inclined or flat position. The inclined position provides superior lateral support for the bikes. The flat position accommodates a wider range of bed length and vehicle wheelbase dimensions. For the inclined position, edge 76 of the second holder 18 is raised and tail gate 84 closed as shown in FIGS. 1 and 9. Wheel engagement in the second holder 18 for inclined and flat positions is shown in FIGS. 9 and 10, respectively.

System 10 includes one or more straps 28, preferably at least two, to securely restrain the bikes in position, both vertically and horizontally. Ratcheting straps formed of polymeric ribbon provide excellent restraint, but other styles can be used, such as inelastic cord or elastic bungees having metal hooks at the ends. Preferably, a forward strap is secured first, extended from one forward side tie-down ring 30, aft and over the bike seat posts and/or handlebar stems, and terminates at the other forward side tie-down ring 30. Alternatively, other truck-based stanchions obviously may be used as tie-down strap attachments. When transporting bicycles, it is preferable to engage each bike securely by wrapping the strap around each seat post and/or handle bar stem. Ratcheting straps provide excellent tension control with low operator effort. Tension from the forward strap 28 firmly presses first wheel(s) 24 into slots 42 in the first holder 16, thus providing downward and forward force to restrain the bike(s) in holder 16.

Wheel base variation between different vehicles is accommodated by fore-and-aft location of second holder 18 in the truck bed. Likewise, a rear strap 28 is installed securing the bike(s) in holder 18 to the rear side tie down rings 30 to provide downward and aft restraining forces on the bike(s). As with the front strap 24, it is preferable to securely engage each bike securely by wrapping the aft strap 28 around each seat post and/or handle bar stem. With forward and aft straps 28 properly tensioned, the bikes are well restrained in all axes thus preventing damage to the bikes, the truck, or others during sudden maneuvering of the truck or in the event of a collision. To provide protection from the elements, a tarp (not shown) can be used to cover the bikes. Since access to tie-downs 28 is unimpeded, the tarp can be securely fastened to the front and rear tie-down rings 30. Anti-theft security for the bikes can be provided with conventional bike locks or chains (not shown) secured from the bike(s) to the truck tie-down rings 30 or to holders 16,18.

Either of first and second holders 16,18 may be formed from sheet metal stock as by punching and stamping, or may be formed from a polymer by a method selected from the group consisting of blow molding, vacuum molding, and injection molding, for example.

A system in accordance with the invention provides a means to mount and transport bikes or other two wheel vehicles, such as motor cycles, motor scooters, ATV's, and even wheelchairs (which may be considered as being two-wheeled) easily, safely, and economically in the bed of a pick up truck or van. The holders are light and easy to install in the truck bed, require no modification of the truck, and also are easily stored by being hung on a wall to preserve valuable garage floor space. Bikes are easy to load into the holders and the mounting straps secure the bikes safely during evasive maneuvering of the transportive vehicle or in the event of a collision. No disassembly of the bikes is required, as in many prior art systems. Since the bikes are carried in the truck bed, they are protected in the event of a collision and are not overly-exposed to road dirt, debris, and water.

While the above exemplary embodiments of the present invention have been applied to open pickup truck beds, it should be understood that the basic principles outlined herein are applicable to other applications. For instance, the holders may be incorporated integrally into a pickup truck bed liner, thus providing the combined utility of a bed liner and a vehicle carrier. Alternatively, the first and/or second holder may be formed integrally with a seat back assembly, floor panel, tail gate, or other interior feature of a van or SUV. This arrangement can add integral vehicle transport capability and value to the interior of the transport vehicle and eliminate the need for purchase and storage of a bicycle carrier while preserving normal vehicle functionality and providing excellent protection from the elements during transport. The concepts are also applicable to the transport of wheeled vehicles other than bicycles such as motorcycles and ATV's. Moreover, while the above description references the use of the system with one or more bikes, it will be understood that the system may be used to secure other types of wheeled vehicles as well.

The embodiments described are chosen to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is described in the following claims.

What is claimed is:

1. A holder for receiving and positioning a first wheel of a wheeled vehicle in a generally upright position, comprising:
a) a plate having a first surface facing toward the axis of said first wheel when in use and a second surface opposite said first surface, said plate having a first generally horizontal edge defining a horizontal direction, said plate having an elongate opening defining a slot extending away from said generally horizontal edge and formed in said plate for receiving said first wheel and for engaging said first wheel at first and second points near the ends of a chord of said first wheel; and
b) a pair of flanges extending orthogonally from one of said first and second surfaces at opposite sides respectively of said slot for engaging said wheel at a third point such that a first plane contained in the rim of said first wheel is generally orthogonal to a second plane contained in said plate.

2. A holder in accordance with claim 1 further comprising a projection extending from said second surface for positioning said plate such that said second plane is non-horizontal in a direction orthogonal to said first generally horizontal edge.

3. A holder in accordance with claim 1 comprising a plurality of said slots and a plurality of said pairs of flanges for receiving and positioning respective first wheels of a plurality of wheeled vehicles.

4. A holder in accordance with claim 1 wherein said first plane is vertical.

5. A holder in accordance with claim 1 wherein said pair of flanges define the sides of an arcuate pocket.

6. A holder in accordance with claim 2 wherein said projection comprises a third flange extending orthogonally of said second plane for engaging a substrate supporting said holder to position said plate non-horizontally.

7. A holder in accordance with claim 1 wherein said pair of flanges extend from said second surface and said third point lies on the periphery of said first wheel.

8. A holder in accordance with claim 1 wherein said pair of flanges extend from said first surface and said third point lies between said chord and said axis.

9. A holder in accordance with claim 1 wherein said vehicle is a two-wheeled vehicle and wherein said first wheel is selected from the group consisting of a front wheel and a rear wheel of said two-wheeled vehicle.

10. A holder in accordance with claim 1 wherein said plate is mountable onto the bed of a transportive vehicle for transporting said wheeled vehicle.

11. A holder in accordance with claim 1 wherein said holder is formed from a polymer by a method selected from the group consisting of blow molding, vacuum molding, and injection molding.

12. A system for transporting a wheeled vehicle in the bed of a transportive vehicle, comprising:
a) a holder for receiving and positioning a first wheel of said wheeled vehicle in a generally upright position, said holder including a plate having a first surface facing toward the axis of said first wheel and a second surface opposite said first surface, said plate having a first generally horizontal edge defining a horizontal direction transverse of said transportive vehicle, said plate having an elongate opening defining a slot extending away from said generally horizontal edge and formed in said plate for receiving said first wheel and for engaging said first wheel at first and second points near the ends of a chord of said first wheel; a pair of flanges extending orthogonally from one of said first and second surfaces at opposite sides respectively of said slot for engaging said first wheel at a third point such that a first plane contained in the rim of said first wheel is generally orthogonal to a second plane contained in said plate; and a positioner for positioning said plate at an attitude such that said second plane is non-horizontal in a direction orthogonal to said first generally horizontal edge; and
b) straps attached to said transportive vehicle and said wheeled vehicle for constraining said wheeled vehicle in a generally upright position against motion both vertically and transversely of said transportive vehicle.

13. A system in accordance with claim 12 wherein said positioner is selected from the group consisting of a projection, a flange, a width of said plate sufficient to cause said plate to form a first angle with a bed wall of said transportive vehicle and a wheel well of said transportive vehicle, and combinations thereof.

14. A system in accordance with claim 12 wherein said strap is provided with a metal hook at least one end thereof.

15. A system in accordance with claim 12 wherein said polymeric ribbon is a ratcheting tie-down.

16. A holder in accordance with claim 12 wherein
said pair of flanges define the sides of a closed arcuate pocket.

17. A holder in accordance with claim 12 wherein said positioner comprises a projection extending orthogonally of said second plane for engaging said bed to position said plate non-horizontally.

18. A system in accordance with claim 12 wherein said holder is positioned in said transportive vehicle forward of said wheeled vehicle.

19. A system in accordance with claim 18 wherein said bed of said transportive vehicle includes a front wall and wheel wells, and wherein said holder is sized to engage said front wall and said wheel wells to position said second plane in said non-horizontal direction orthogonal to said first generally horizontal edge.

20. A system in accordance with claim 12 wherein said holder is positioned in said transportive vehicle aft of said wheeled vehicle.

21. A system in accordance with claim 20 wherein said bed of said transportive vehicle includes a rear wall, which may be a pivotable tailgate, and wheel wells, and wherein said holder is sized to engage said rear wall and said wheel wells to position said second plane in said non-horizontal direction orthogonal to said first generally horizontal edge.

22. A system in accordance with claim 12 wherein said holder is a first holder, and wherein said system further comprises a second holder for receiving and positioning a second wheel of said wheeled vehicle in a generally upright position, wherein said second holder is substantially identical with said first holder.

23. A system in accordance with claim 12 wherein
said holder is a first holder, and wherein said system further comprises a second holder for receiving and positioning a second wheel of said wheeled vehicle in a generally upright position,
wherein said second holder includes a second plate having a first surface facing toward the axis of said second wheel and a second surface opposite said first surface and facing said bed of said transportive vehicle, said second plate having a first generally horizontal edge defining a horizontal direction transverse of said transportive vehicle, said second plate having an elongate opening defining a slot extending away from said generally horizontal edge and formed in said plate for receiving said second wheel and for engaging said second wheel at first and second points along a chord of said second wheel; a pair of flanges extending orthogonally from said first surface at opposite sides respectively of said slot for engaging said second wheel at a third point such that a first plane contained in the rim of said wheel is generally orthogonal to a second plane contained in said plate.

24. A system in accordance with claim 12 comprising a plurality of said slots and a plurality of said pairs of flanges for receiving and positioning respective first wheels of a plurality of wheeled vehicles.

25. A system in accordance with claim 12 wherein said holder is formed integrally with one or more interior elements of a vehicle.
